(19) United States
(12) Patent Application Publication
(10) Pub. No.: US 2021/0365883 A1
(43) Pub. Date: Nov. 25, 2021

(54) SYSTEMS AND METHODS FOR GENERATING AND DISPLAYING REAL-TIME DELIVERY ESTIMATES

(71) Applicant: AutoZone Parts, Inc., Memphis, TN (US)

(72) Inventors: Earl Whitfield Marbut, JR., Hernando, MS (US); Ronald Blair Griffin, Memphis, TN (US); Lindsey Elizabeth Luther, Hernando, MS (US); Manoj Swaroopam Koratty, Collierville, TN (US)

(21) Appl. No.: 16/881,593

(22) Filed: May 22, 2020

(51) Int. Cl. G06Q 10/08; G06Q 30/06; G06N 20/00

(52) U.S. Cl. CPC G06Q 10/0838; G06N 20/00; G06Q 30/0643; G06Q 10/087

(57) ABSTRACT

The present disclosure provides computer systems, apparatuses, methods, and computer readable media for generating and displaying real-time delivery estimates. An example method includes initializing a customer session, receiving customer session data associated with the customer session comprising customer data, store network data, delivery network data, and shopping cart data, identifying one or more products to be displayed via a user interface, receiving product inventory data about the one or more products, the product inventory data including a product data structure providing information about each product in the one or more products, generating a first real-time delivery estimate for each of the one or more products based on the customer session data and the product inventory data, and displaying, by a user interface, the one or more products and the first real-time delivery estimate for each of the one or more products relative to the corresponding product.

### TECHNOLOGICAL FIELD

Example embodiments of the present disclosure relate generally to delivery systems and, more particularly, to systems, methods, and apparatuses for generating and displaying real-time delivery estimates.

### BACKGROUND

In fast-paced industries, fulfilling consumer demand is tied to the delivery of products. In some instances, the cost of waiting on the delivery of a product may be significant, and customer purchasing decisions may change if the customer has access to granular time of delivery estimates for products. Thus, efficiently generating delivery estimates before a customer places an order may result in more informed purchase decisions, increases in sales, and more loyalty from customers.

### BRIEF SUMMARY

The advent of computers coupled with faster, more efficient modes of transportation has led to a logistical revolution. Highly sophisticated logistical networks can now deliver products from around the world in record time. At the same time, conventional delivery systems can display high-level delivery estimates and, in some cases, track products after a delivery is ordered. However, in time sensitive environments, where even small delays in delivery carry real-world costs, further logistical information is required to enable customers to make fully informed order decisions. For instance, a delivery system capable of generating precise, accurate, real-time delivery estimates can provide vital timing information to its users. Moreover, a dynamic user interface capable of providing accurate real-time delivery estimates regarding each product available for delivery enables a user to place an order in a way that optimizes outcomes based on timing. By seamlessly allowing a user to view relevant timing information before a product is selected, a delivery interface can increase the flexibility and speed of conventional delivery systems. In turn, improved delivery estimation, as well as ways to visualize such delivery estimates for users would transform the use of historically opaque customer interfaces to enable more nuanced product filtering.

Embodiments described herein provide for generating and displaying precise real-time delivery estimates corresponding to one or more products before placing a delivery order. An example embodiment initializes a customer session and receives data related to a customer, set of stores, delivery network, virtual shopping cart, and product inventories. Based on the received data, the example embodiment generates a real-time delivery estimate for each of one or more products and provides the estimate relative to the corresponding product to a user via a user interface. Unlike conventional delivery systems, example embodiments described herein provide real-time delivery estimates to a user before a product is selected for delivery, thereby enabling the user to more efficiently account for delivery delays associated with different products or different combinations of products. This is critical, for example, in service industries with limited space, such as an auto repair garage, where the opportunity cost of keeping a vehicle bay full while waiting for the delivery of a product may outweigh the benefit of servicing a particular vehicle in the first place. Thus, dynamic real-time delivery estimates, in accordance to example embodiments described herein, offer a technical improvement over conventional delivery systems by enabling increased user control through more nuanced product filtering based on displayed changes to estimated delivery times. Rather than requiring a user to navigate through multiple windows to view/calculate delivery estimates, the real-time delivery estimates of example embodiments described herein are displayed automatically even while the user is building an order. These real-time delivery estimates increase the efficiency and speed of generating delivery orders by automatically displaying precise timing estimates that dynamically change depending on user input, thereby allowing the user to manipulate a delivery order based on timing constraints.

In one example embodiment, a computer-implemented method is provided for generating and displaying real-time delivery estimates, the method comprising initializing a customer session; receiving customer session data associated with the customer session, the customer session data comprising customer data, store network data, delivery network data, and shopping cart data, wherein the shopping cart data identifies one or more products in a virtual shopping cart associated with the customer session; identifying one or more products to be displayed via a user interface; receiving product inventory data about the one or more products, the product inventory data including a product data structure providing information about each product in the one or more products; generating a first real-time delivery estimate for each of the one or more products based on the customer session data and the product inventory data; and displaying, by a user interface, the one or more products and each corresponding first real-time delivery estimate.

In some embodiments, the product data structure identifies, for each particular product in the one or more products, one or more locations having the particular product in stock, a quantity of the particular product available at each of the one or more locations having the particular product in stock, and a pickup cost and/or delivery period associated with retrieving the particular product from each of the one or more locations.

In some embodiments, the computer-implemented method further comprises storing, in a first local memory, the customer session data; and storing, in a second local memory, at least a portion of the product inventory data.

In some embodiments, the computer-implemented method further comprises determining a portion of the product inventory data to be stored based on a product sale rate corresponding to each of the one or more products.

In some embodiments, generating a first real-time delivery estimate for a particular product comprises: determining a delivery path associated with the particular product based on the customer session data and the product inventory data; and generating the first real-time delivery estimate for the particular product based on the delivery path.

In some embodiments, the computer-implemented method further comprises receiving one or more error rates. The computer-implemented method may further comprise modifying the first real-time delivery estimate for each of the one or more products based on the one or more error rates.

In some embodiments, the computer-implemented method further comprises receiving one or more relevance scores, wherein the one or more relevance scores are determined, using machine learning techniques, for one or more historical components of historical data. In some such embodiments, the computer-implemented method further comprises modifying the first real-time delivery estimate for each of the one or more products based on the one or more relevance scores.

In some embodiments, the computer-implemented method further comprises receiving, by a user interface, a user input indicating an addition of one or more new products to the virtual shopping cart; updating the virtual shopping cart based on the user input; and refreshing the first real-time delivery estimate for each of the one or more products based on the shopping cart data.

In some embodiments, the computer-implemented method further comprises receiving, by a user interface, a user input indicating an order request; generating a second real-time delivery estimate for the one or more products in the virtual shopping cart; displaying, by a user interface, the second real-time delivery estimate; receiving an actual delivery time (following delivery of the one or more products); and storing, in a memory, order submission data identifying the customer session data associated with the customer session, the second real-time delivery estimate, the actual delivery time, current traffic data, current environmental data, and current local event data.

In another example embodiment, an apparatus is provided for generating and displaying real-time delivery estimates, the apparatus comprising customer session circuitry configured to initialize a customer session; and receive customer session data associated with the customer session, the customer session data comprising customer data, store network data, delivery network data, and shopping cart data, wherein the shopping cart data identifies one or more products in a virtual shopping cart associated with the customer session; delivery estimate circuitry configured to receive product inventory data about one or more products, the product inventory data including a product data structure providing information about each product in the one or more products; and generate a first real-time delivery estimate for each of the one or more products based on the customer session data and the product inventory data; user interface circuitry configured to identify one or more products to be displayed via a user interface; and display, via a user interface, the one or more products and each corresponding first real-time delivery estimate.

In some embodiments, the product data structure identifies, for each particular product in the one or more products, one or more locations having the particular product in stock, a quantity of the particular product available at each of the one or more locations having the particular product in stock, and a pickup cost and/or delivery period associated with retrieving the particular product from each of the one or more locations.

In some embodiments, the apparatus further comprises customer session circuitry further configured to store, in a first local memory, the customer session data; and partial product inventory circuitry configured to store, in a second local memory, at least a portion of the product inventory data.

In some embodiments, the partial product inventory circuitry is further configured to determine a portion of the product inventory data to be stored based on a product sale rate corresponding to each of the one or more products.

In some embodiments, the delivery estimate circuitry is further configured to generate a first real-time delivery estimate for a particular product by determining a delivery path associated with the particular product based on the customer session data and the product inventory data; and generating the first real-time delivery estimate for the particular product based on the delivery path.

In some embodiments, the delivery estimate circuitry is further configured to receive one or more error rates, wherein the one or more error rates are determined by a reconciliation engine based on historical data. In some such embodiments, the delivery estimate circuitry is further configured to modify the first real-time delivery estimate for each of the one or more products based on the one or more error rates.

In some embodiments, the delivery estimate circuitry is further configured to receive one or more relevance scores, wherein the one or more relevance scores are determined, using machine learning techniques, for one or more historical components of historical data. In some such embodiments, the delivery estimate circuitry is further configured to modify the first real-time delivery estimate for each of the one or more products based on the one or more relevance scores.

In some embodiments, the apparatus further comprises user interface circuitry further configured to receive, by a user interface, a user input indicating an addition of one or more new products to the virtual shopping cart; and update the virtual shopping cart, based on the user input; and delivery estimate circuitry further configured to refresh the first real-time delivery estimate for each of the one or more products in response to the user input.

In some embodiments, the apparatus further comprises delivery estimate circuitry further configured to generate a second real-time delivery estimate for the one or more products in the virtual shopping cart; and user interface circuitry further configured to receive, by a user interface, a user input indicating an order request; display, by a user interface, a second real-time delivery estimate; receive an actual delivery time (following delivery of the one or more products); and store, in a memory, order submission data identifying the customer session data associated with the customer session, the second real-time delivery estimate, the actual delivery time, current traffic data, current environmental data, and current local event data.

The foregoing brief summary is provided merely for purposes of summarizing some example embodiments illustrating some aspects of the present disclosure. Accordingly, it will be appreciated that the above-described embodiments are merely examples and should not be construed to narrow the scope of the present disclosure in any way. It will be appreciated that the scope of the present disclosure encompasses many potential embodiments in addition to those summarized herein, some of which will be described in further detail below.

### BRIEF DESCRIPTION OF THE FIGURES

Having described certain example embodiments of the present disclosure in general terms above, reference will now be made to the accompanying drawings, which are not necessarily drawn to scale. Some embodiments may include fewer or more components than those shown in the figures.

FIG. 1 illustrates an example delivery system 100 within which embodiments of the present disclosure may operate to generate and display real-time delivery estimates.

FIG. 2 illustrates a schematic block diagram of example circuitry embodying a delivery data system device that may perform various operations in accordance with some example embodiments described herein.

FIG. 3 illustrates a schematic block diagram of example circuitry embodying a delivery system customer device that may perform various operations in accordance with some example embodiments described herein.

FIG. 4 illustrates an example flowchart for generating and displaying one or more real-time delivery estimates corresponding to one or more products in accordance with some example embodiments described herein.

FIG. 5 illustrates an example flowchart for receiving and responding to user input, via a user interface, in accordance with some example embodiments described herein.

FIG. 6 illustrates another example flowchart for generating one or more real-time delivery estimates corresponding to one or more products in accordance with some example embodiments described herein.

FIG. 7 illustrates an example user interface provided to a user of the delivery system in accordance with some example embodiments described herein.

FIGS. 8A-D illustrate additional example user interfaces provided to a user of the delivery system in accordance with some example embodiments described herein.

### DETAILED DESCRIPTION

Some embodiments of the present disclosure will now be described more fully hereinafter with reference to the accompanying figures, in which some, but not all embodiments of the disclosures are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout.

Where the specification states that a particular component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such terminology is intended to convey that the particular component or feature is included in some embodiments while excluded in others, or has the characteristic in some embodiments while lacking the characteristic in others.

The term “computing device” is used herein to refer to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” is used to refer to any computing device capable of functioning as a server, such as a master exchange server, web server, mail server, document server, or any other type of server. A server may be a dedicated computing device or a server module (e.g., an application) an application hosted by a computing device that causes the computing device to operate as a server. A server module (e.g., server application) may be a full function server module, or a light or secondary server module (e.g., light or secondary server application) that is configured to provide synchronization services among the dynamic databases on computing devices. A light server or secondary server may be a slimmed-down version of server type functionality that can be implemented on a computing device, such as a smart phone, thereby enabling it to function as an Internet server (e.g., an enterprise e-mail server) only to the extent necessary to provide the functionality described herein.

The term “external data” refers to data retrieved by the system from external data sources. For example, external data may refer to information identified by a GPS device such as map data or traffic data. Additionally or alternatively, external data may include weather information identified by weather services, local information identified by local news services, etc.

The term “high performance cache” is used to refer to a cache memory (i.e., reserved areas of memory). Cache memory is meant to be generic for any intermediate level of memory between the execution unit and the main memory. Caches are typically smaller and faster than main memory, and are used to store temporary information. For example, in some embodiments, caches can be used to store relevant information for the life of a customer session.

### Overview

As noted above, systems, methods, and apparatuses are described herein that provide for the generation and display of real-time delivery estimates. Traditionally, it has been very difficult to predict delivery times. In addition, there is typically no way to dynamically create an order of one or more products based on delivery times associated with each product.

In contrast to conventional techniques for generating delivery orders, the present disclosure describes systems, methods, and apparatuses that dynamically provide real-time delivery estimates for one or more products to a user before and during the creation of one or more delivery orders. The systems, methods, and apparatuses of the present disclosure initialize a customer session associated with one or more customers. In addition, the systems, methods, and apparatuses of the present disclosure receive information related to a customer, set of stores, delivery network, virtual shopping cart, and product inventories and places relevant information in local memory such as in one or more high performance caches. Based on the received information, the systems, methods, and apparatuses of the present disclosure identify one or more products to display along with relevant product information. In this regard, the systems, methods, and apparatuses of the present disclosure leverage an abundance of data including the customer, set of stores, delivery network, virtual shopping cart, and product inventory data to identify an efficient path associated with each of the identified products. Based on this data and the determined path associated with each of the one or more products, the systems, methods, and apparatuses of the present disclosure generate a precise real-time delivery estimate for each of the one or more products. The systems, methods, and apparatuses of the present disclosure then display, to a user and via a dynamic user interface, each of the identified products in connection with its corresponding real-time delivery estimate. The one or more identified products are shown to the user before the user selects the product for delivery, thus enabling users to see an upfront delivery estimate before making a purchasing decision. Furthermore, the systems, methods, and apparatuses of the present disclosure tracks the user's perusal of the user interface and refreshes displayed product information based on user input. In this manner, the systems, methods, and apparatuses of the present disclosure provide up-to-date, accurate, holistic product information regarding each of the one or more products identified for display.

Accordingly, the present disclosure sets forth systems, methods, and apparatuses that achieve the goal of generating and displaying precise real-time delivery information to a user. There are many advantages of these and other embodiments described herein.

For instance, by generating and displaying delivery estimates before a product is selected for delivery, example embodiments provide tools that overcome the problems faced by conventional delivery systems. Conventional delivery systems lacked the capability of estimating delivery estimates in real-time. Thus, service providers have traditionally been forced to rely on manually generated rough estimates based on past experience. For instance, a mechanic at an auto repair garage may, based on the knowledge of a product's location, guess a rough time frame for when to expect the delivery of a particular product. But rough estimates of this nature are, by definition, inaccurate. Accordingly, by avoiding the need to perform these manual delivery “guesstimates” for each product, examples described herein save time and resources, while also avoiding the human error that has been unavoidable in the past. Moreover, the speed and consistency of the evaluations performed by examples described herein unlock many potential new functions that have historically not been available, such as the ability to generate precise real-time delivery estimates accurate to within a target range 5-10 minutes even when those estimates depend on a number of dynamically changing variables.

Furthermore, by providing dynamic real-time delivery estimates before an order is created, user interfaces of examples described herein allow the user to create a more informed order based on a more holistic depiction of the delivery difficulty of each of the products being requested. The real-time delivery estimates may be generated for each product before products are selected for delivery (e.g., added to a virtual shopping cart). Moreover, the delivery estimates are constantly refreshed to reflect information associated with a user's perusal of the user interface. Because delays in deliveries can cost money—especially true in service industries with limited operational space and/or time—the fact that examples described herein provide precise and up-to-date real-time delivery estimates illustrates why these examples are vital technical tools serving real-world goals. In this regard, systems, methods, and apparatuses of the present disclosure can provide a user interface capable of displaying delivery estimates in real-time accurate to within a target range of 5-10 minutes, and in doing so, improving upon the functionality of e-commerce portals associated with conventional delivery systems.

Finally, storing data locally, such as in one or more high performance caches, increases the efficiency and speed of conventional delivery systems by facilitating frequent queries for relevant data required for generating and displaying accurate real-time delivery estimates. For instance, placing frequently accessed data within one or more high performance caches increases the speed of data retrieval, which in turn increases a platform's flexibility in generating delivery estimates. Furthermore, by placing relevant information locally and close to an e-commerce platform, the examples described herein facilitate seamlessly refreshing of displayed information, providing a more responsive user interface, and which enables more nuanced product filtering based on the automatically displayed changes to delivery times.

Although a high level explanation of the operations of example embodiments has been provided above, specific details regarding the configuration of such example embodiments are provided below.

### System Architecture

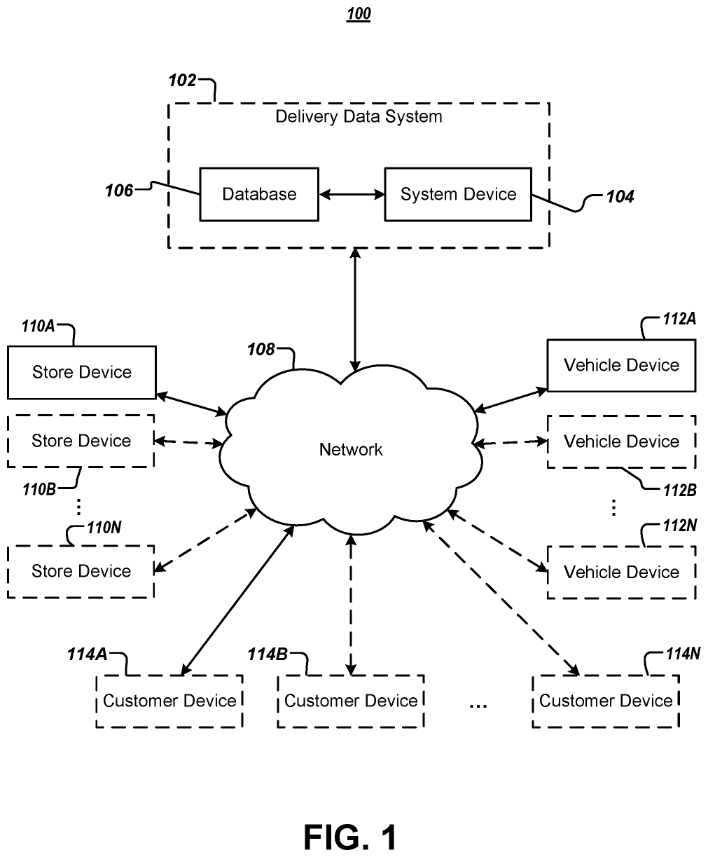

Example embodiments described herein may be implemented using any of a variety of computing devices or servers. To this end, FIG. 1 illustrates an example delivery system 100 within which embodiments of the present disclosure may operate to generate real-time delivery estimates. As illustrated, a delivery data system 102 may include one or more system devices 104 in communication with one or more databases 106. The delivery data system 102 any of the constituent system devices 104 and/or databases 106 may in turn receive information from, and transmit information to, the one or more store devices 110A-110N, one or more vehicle devices 112A-112N, and one or more customer devices 114A-114N. Transmission of such information may be facilitated by a network 108, such as the Internet.

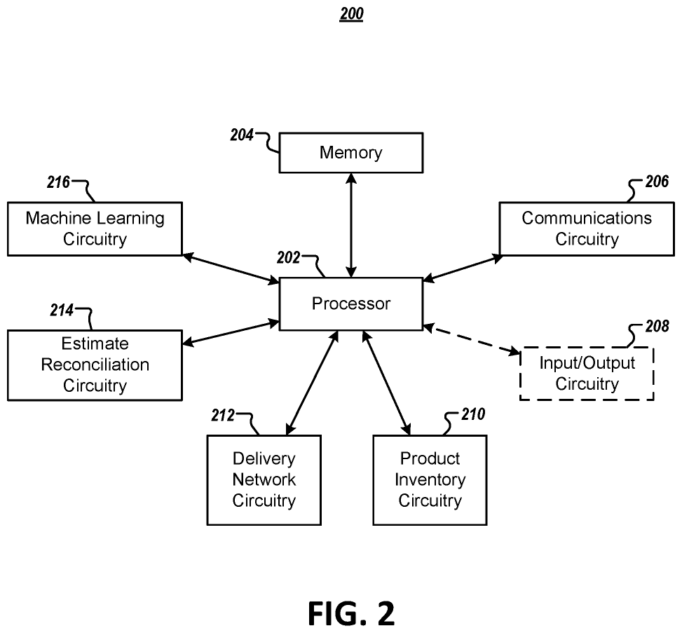

The one or more system devices 104 may be embodied as one or more servers, such as that described below in connection with FIG. 2. The one or more system devices 104 may further be implemented as local servers, remote servers, cloud-based servers (e.g., cloud utilities), or any combination thereof. The one or more system devices 104 may receive, process, generate, and transmit data, signals, and electronic information to facilitate the operations of the delivery data system 102. The one or more databases 106 may be embodied as one or more data storage devices, such as a Network Attached Storage (NAS) device or devices, or as one or more separate databases or servers. The one or more databases 106 may store information accessed by the delivery data system 102 to facilitate the operations of the delivery data system 102. For example, the one or more databases 106 may store control signals, device characteristics, and access credentials for one or more of the store devices 110A-110N or vehicle devices 112A-112N.

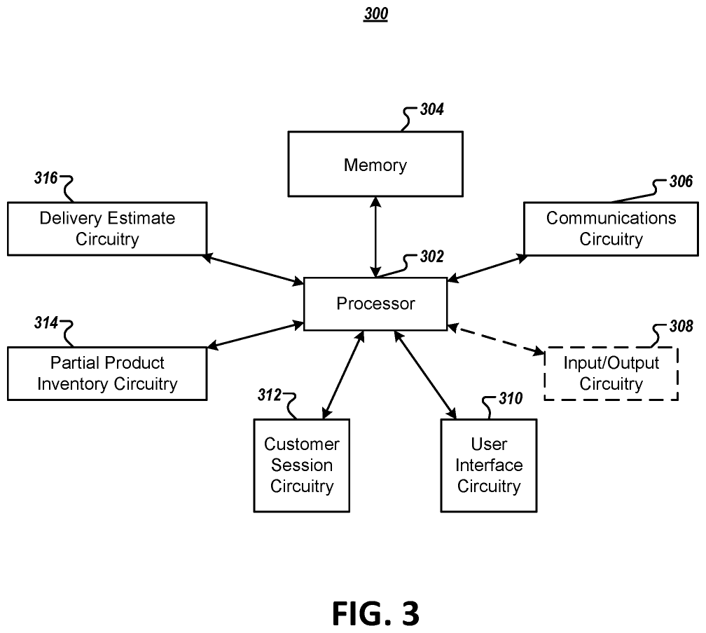

The one or more store devices 110A-110N, the one or more vehicle devices 112A-112N, and the one or more customer devices 114A-114N may be embodied by any computing devices known in the art. For instance, the one or more store devices 110A-110N may be embodied by devices described below in connection with FIG. 3. The delivery data system 102 may receive information from, and transmit information to, the one or more store devices 110A-110N and/or the one or more vehicle devices 112A-112N. For example, the delivery data system 102 may receive product inventory data associated with each of the one or more store devices 110A-110N from each of one or more store devices 110A-110N and transmit product inventory data associated with the one or more store devices 110A-110N to one or more of the store devices 110A-110N, one or more vehicle devices 112A-112N, and/or one or more customer devices 114A-114N. Moreover, the delivery data system 102 may receive delivery network data from each of the one or more vehicle devices 112A-112N and transmit the delivery network data to the one or more store devices 110A-110N, the one or more customer devices 114A-114N, and/or the one or more vehicle devices 112A-112N. In this way, the delivery data system 102 may collect data relevant to deliveries and transmit relevant data to store devices 110A-110N, vehicle devices 112A-112N, and/or customer devices 114A-114N.

It will be understood that in some embodiments, the one or more store devices 110A-110N, the one or more customer devices 114A-114N, and the one or more vehicle devices 112A-112N need not themselves be independent devices, but may be peripheral devices communicatively coupled to other computing devices.

### Example Implementing Apparatuses

The delivery data system 102 described with reference to FIG. 1 may be embodied by one or more computing devices or servers, such as the apparatus 200 shown in FIG. 2. As illustrated in FIG. 2, the apparatus 200 may include processor 202, memory 204, communications circuitry 206, input/output circuitry 208, product inventory circuitry 210, delivery network circuitry 212, estimate reconciliation circuitry 214, and machine learning circuitry 216, each of which will be described in greater detail below. In some embodiments, the apparatus 200 may further comprise a bus (not expressly shown in FIG. 2) for passing information between various components of the apparatus. The apparatus 200 may be configured to execute various operations described above in connection with FIG. 1 and below in connection with the remaining figures.

In some embodiments, the processor 202 (and/or co-processor or any other processing circuitry assisting or otherwise associated with the processor) may be in communication with the memory 204 via a bus for passing information among components of the apparatus. The processor 202 may be embodied in a number of different ways and may, for example, include one or more processing devices configured to perform independently. Additionally or alternatively, the processor may include one or more processors configured in tandem via a bus to enable independent execution of software instructions, pipelining, and/or multithreading. The use of the terms “processor” or “processing circuitry” may be understood to include a single core processor, a multi-core processor, multiple processors of the apparatus 200, remote or “cloud” processors, or any combination thereof.

In an example embodiment, the processor 202 may be configured to execute software instructions stored in the memory 204 or otherwise accessible to the processor. Alternatively or additionally, the processor may be configured to execute hard-coded functionality. As such, whether configured by hardware or software methods, or by a combination of hardware with software, the processor 202 may represent an entity (e.g., physically embodied in circuitry) capable of performing operations according to an embodiment of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories including one or more designated high performance caches. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications circuitry 206 may be any means such as a device or circuitry embodied in either hardware or a combination of hardware and software that is configured to receive and/or transmit data from/to a network and/or any other device, circuitry, or module in communication with the apparatus 200. In this regard, the communications circuitry 206 may include, for example, a network interface for enabling communications with a wired or wireless communication network. For example, the communications circuitry 206 may include one or more network interface cards, antennas, buses, switches, routers, modems, and supporting hardware and/or software, or any other device suitable for enabling communications via a network. Additionally or alternatively, the communications circuitry 206 may include the circuitry for causing transmission of such signals to a network or to handle receipt of signals received from a network.

In some embodiments, the apparatus 200 may include input/output circuitry 208 in communication configured to provide output to a user and, in some embodiments, to receive an indication of user input. The input/output circuitry 208 may comprise a user interface, such as a display, and may further comprise the components that govern use of the user interface, such as a web browser, mobile application, dedicated client device, or the like. In some embodiments, the input/output circuitry 208 may additionally or alternatively include a keyboard, a mouse, a touch screen, touch areas, soft keys, a microphone, a speaker, and/or other input/output mechanisms. The input/output circuitry 208 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises product inventory circuitry 210, which includes hardware components designed for collecting, organizing, storing, and transmitting product inventory data. The product inventory circuitry 210 may utilize processor 202, memory 204, or any other hardware component included in the apparatus 200 to perform these operations. The product inventory circuitry 210 may further utilize communications circuitry 206 to collect product inventory data from one or more store devices 110A-110N and transmit product inventory data to one or more store devices 110A-110N, one or more vehicle devices 112A-112N, and/or one or more customer devices 114A-114N. In some embodiments, the product inventory circuitry 210 may receive updated product inventory data from the one or more store devices 110A-110N upon identifying the occurrence of a product inventory refresh trigger, which may in turn be signaled by receipt of data from a store device 110. For example, in some cases, the product inventory circuitry 210 may receive updated product inventory data from each of the one or more store devices 110A-110N at a predetermined time interval. Moreover, in some instances, the product inventory circuitry 210 may receive updated product inventory data from each of the one or more store devices 110A-110N upon identifying a change in product inventory data associated with a particular store device 110A-110N. For instance, each of the one or more store devices 110A-110N may be configured to transmit changes to product inventory data to product inventory circuitry 210 upon identification of the changes to that store's product inventory data. The product inventory circuitry 210 may further utilize processor 202 to organize and store product inventory data within memory 204.

As used herein, product inventory data relates to inventory information associated with one or more products. In some embodiments, the product inventory data may comprise data about the one or more products. In this regard, the product inventory data may include a data structure providing information about each product in the one or more products. For example, in some embodiments, the data structure providing information about a particular product identifies one or more locations having the particular product in stock, a quantity of the particular product available at each of the one or more locations having the particular product in stock, and a pickup cost and/or time associated with retrieving the particular product from each of the one or more locations. The pickup cost or time associated with retrieving a particular product from a location may, in some embodiments, indicate an average amount of time needed to locate and load the product from a particular store. In some embodiments, the pickup cost associated with a product may be assigned or determined based on factors such as size, weight, location within a store, and/or findability, etc. Moreover, the data structure may identify one or more product characteristics such as, but not limited to, a particular product's sales rate, sales history, and/or market appeal.

In addition, the apparatus 200 further comprises delivery network circuitry 212, which includes hardware components designed for collecting, organizing, storing, and transmitting delivery network data. The delivery network circuitry 212 may utilize processor 202, memory 204, or any other hardware component included in the apparatus 200 to perform these operations. The delivery network circuitry 212 may further utilize communications circuitry 206 to collect delivery network data from one or more vehicle devices 112A-112N and transmit delivery network data to one or more store devices 110A-110N, the one or more customer devices 114A-114N, and/or one or more vehicle devices 112A-112N. In some embodiments, the delivery network circuitry 212 may be configured to receive updated delivery network data from the one or more vehicle devices 112A-112N upon identifying the occurrence of a delivery network refresh trigger. For example, in some cases, the delivery network circuitry 212 may receive updated delivery network data from the vehicle devices 112A-112N at a predetermined time interval. Moreover, in some cases, the delivery network circuitry 212 may receive updated delivery network data from the vehicle devices 112A-112N upon a change in delivery network data associated with one or more of the vehicle devices 112A-112N. For instance, each of the one or more vehicle devices 112A-112N may be configured to transmit changes to delivery network data to delivery network circuitry 212. The delivery network circuitry 212 may further utilize processor 202 to organize and/or store the delivery network data within memory 204.

In some embodiments, the delivery network data may comprise one or more vehicles associated with the vehicle devices 112A-112N. The one or more vehicles may include any type of autonomous or manned vehicle. For instance, the delivery network data may comprise any combination of cars, trucks, water vessels, airplanes, drones, or any other vehicle, manned or unmanned. In addition, the delivery network data may include a vehicle data structure providing information about each of the one or more vehicles. For instance, the vehicle data structure may identify one or more locations, tasks, and/or time availabilities associated with each of the one or more vehicles. Additionally, the vehicle data structure may identify vehicle information such as a vehicle identification number, type, delivery range, last date of service, minimum or maximum load size or weight, and/or current condition, etc. The vehicle data structure may be received from the vehicle devices 112A-112N directly, or from a third party courier or delivery service having a fleet of vehicles, or a combination of both.

In some embodiments, the delivery network data may include data about one or more drivers associated with the vehicle devices 112A-112N. In addition, the delivery network data may include a driver data structure providing information about each of the one or more drivers. For instance, the driver data structure may identify one or more locations, tasks, and/or time availabilities associated with each of the one or more drivers. Additionally, the driver data structure may identify driver information such as a driver's name, identification, license number, work schedule, tendencies, and/or contact information, etc.

The one or more locations associated with each of the one or more vehicles and/or drivers may identify a vehicle and/or driver's current location, previous location, next planned location, etc. The one or more tasks may identify any information relevant to an assigned task such as one or more planned stops, products, and/or customers, etc. Time availabilities may indicate one or more times when a vehicle and/or driver is expected to be free to accept a new task.

The location, task and time availability information may be predetermined such as by a work schedule assignment or, in some cases, dynamically determined by the delivery network circuitry 212. For example, in some embodiments, the delivery network circuitry 212 may dynamically determine one or more locations based on changes to the task data associated with the vehicle and/or driver. For instance, if the task data identifies a product at a particular store, the delivery network circuitry 212 may identify the location of the particular store as a planned location. Moreover, in some embodiments, the delivery network circuitry 212 may dynamically determine time availability data associated with each of the one or more vehicles and/or drivers based on the one or more locations or tasks associated with the vehicle. For instance, if a task associated with a vehicle and/or driver is scheduled to take 20 minutes to complete and a location associated with the corresponding vehicle device 112 indicates that the vehicle and/or driver is halfway through completing the task, the delivery network circuitry 212 may dynamically adjust the time availability to within 10 minutes. In this regard, the delivery network circuitry 212 may use any number of additional factors such as external data including map or GPS data to dynamically determine the one or more vehicle and/or driver locations, tasks, or time availabilities.

In some embodiments, the delivery network data may identify one or more linked vehicles and drivers. In this regard, the delivery network circuitry 212 may dynamically assign one or more drivers to one or more vehicles based on one or more factors. For instance, in some embodiments, the delivery network circuitry 212 may dynamically assign a driver to one or more vehicles at a particular time depending on the vehicle's availability, current condition, type, delivery range, last date of service, or any other factor affecting the drivability of the vehicle. In another embodiment, the driver may be permanently associated with one or more vehicles. For example, a driver may own a particular vehicle and consequently be permanently assigned to the owned vehicle. Information about a given linked vehicle or driver may then be collected from a single vehicle device 112 nominally associated with only one of the vehicle or the driver that are linked together.

In addition, the apparatus 200 also comprises estimate reconciliation circuitry 214, which includes hardware components designed for collecting, organizing, storing, analyzing and transmitting historical data. The estimate reconciliation circuitry 214 may utilize processor 202, memory 204, or any other hardware component included in the apparatus 200 to perform these operations. The estimate reconciliation circuitry 214 may further utilize communications circuitry 206 to collect historical data from the one or more store devices 110A-110N and/or the one or more vehicle devices 112A-112N, or may otherwise utilize processor 202 and/or memory 204 to organize, analyze and store the historical data within the memory 204.

As used herein, historical data relates to information associated with one or more past deliveries. In some embodiments, the historical data may include a delivery data structure providing information about past deliveries. For instance, in some embodiments, the delivery data structure may identify an originally estimated time of delivery and an actual time of delivery associated with a given past delivery. In some embodiments, the delivery data structure may also identify traffic data, environmental data, and/or local event data relating to the past delivery that ostensibly contributed to the actual time required to complete the deliver. It will be understood that the historical data is not limited solely to these particular examples, and instead may comprise any historical information used to develop a delivery or that may have an effect on a delivery.

In some embodiments, the estimate reconciliation circuitry 214 determines one or more error rates associated with the historical data. In this regard, the estimate reconciliation circuitry 214 may determine, based on stored historical data, an average difference between the one or more estimated times of delivery for a past delivery and the corresponding actual times of delivery of the past delivery. Moreover, the estimate reconciliation circuitry 214 may store the one or more error rates in memory 204 and update the one or more error rates upon the identification of one or more triggers. For example, the estimate reconciliation circuitry 214 may include a timer and a preset time interval. The estimate reconciliation circuitry 214 may update the one or more error rates at the completion of every time interval. In another embodiment, the estimate reconciliation circuitry 214 may track changes to historical data and update the one or more error rates as new historical data is received.

Finally, the apparatus 200 also comprises machine learning circuitry 216, which includes hardware components designed for organizing, analyzing and transmitting components of historical data. The machine learning circuitry 216 may utilize processor 202, memory 204, or any other hardware component included in the apparatus 200 to perform these operations. The machine learning circuitry 216 may further utilize communications circuitry 206 to receive customer session data from store devices 110A-110N and transmit one or more relevance scores associated with the historical data to the store devices 110A-110N, or may otherwise utilize processor 202 to analyze the components of historical data and store the components of historical data within memory 204.

As used herein, components of historical data may comprise any combination of the historical data described above. For example, the machine learning circuitry 216 may organize the historical data into one or more components based on one or more characteristics shared by the historical data. For instance, in one embodiment, one component of historical data may share one or more past deliveries associated with particular weather patterns. For example the component of historical data may indicate one or more past deliveries made during a thunderstorm. Alternatively, as another example, another component of historical data may share one or more past deliveries of one or more similar products and/or product locations. For example, the component of historical data may indicate one or more past deliveries of one or more products from a particular store.

In some embodiments, the machine learning circuitry 216 may determine one or more relevance scores for one or more components of historical data based on data associated with a customer session such as customer session data, product inventory data, current traffic data, environmental data, local event data, etc. The machine learning circuitry 216 may determine relevance scores using any number of machine learning techniques such as, but not limited to, neural networks, fuzzy networks, genetic algorithms, evolutionary strategies, or the like. In some embodiments, the machine learning circuitry 216 may determine one or more correlations between data associated with a current customer session received from one or more store devices 110A-110N and/or the one or more customer devices 114A-114N, and the one or more components of the historical data. Moreover, the machine learning circuitry 216 may determine one or more relevance scores associated with the one or more components of historical data based on the one or more determined correlations between the data associated with a current customer session and the one or more components of the historical data.

For example, as described in further detail below, the machine learning circuitry 216 may receive current customer session data indicative of a thunderstorm. In response, the machine learning circuitry 216 may determine a correlation between the current customer data and a component of historical data associated with past deliveries made during thunderstorms. Based on this correlation, the machine learning circuitry 216 may determine one or more relevance scores and transmit the one or more relevance scores to one or more store devices 110A-110N and/or the one or more customer devices 114A-114N.

Although these components 202-216 may in part be described using functional language, it will be understood that the particular implementations necessarily include the use of particular hardware. It should also be understood that certain of these components 202-216 may include similar or common hardware. For example, the product inventory circuitry 210, delivery network circuitry 212, estimate reconciliation circuitry 214, and machine learning circuitry 216 may each at times leverage use of the processor 202 or memory 204, but duplicate hardware is not required to facilitate operation of these distinct components of the apparatus 200 (although duplicated hardware components may be used in some embodiments, such as those in which enhanced parallelism may be desired). The use of the term “circuitry” as used herein with respect to components of the apparatus therefore shall be interpreted as including the particular hardware configured to perform the functions associated with the particular circuitry described herein. While the term “circuitry” should be understood broadly to include hardware, in some embodiments, the term “circuitry” may refer also to software instructions that configure the hardware components of the apparatus 200 to perform their various functions.

To this end, each of the communications circuitry 206, input/output circuitry 208, product inventory circuitry 210, delivery network circuitry 212, estimate reconciliation circuitry 214, and machine learning circuitry 216 may include one or more dedicated processors, specially configured field programmable gate arrays (FPGA), or application specific interface circuits (ASIC) to perform its corresponding functions, these components may additionally or alternatively be implemented using a processor (e.g., processor 202) executing software stored in a memory (e.g., memory 204). In this fashion, the communications circuitry 206, input/output circuitry 208, product inventory circuitry 210, delivery network circuitry 212, estimate reconciliation circuitry 214, and machine learning circuitry 216 are therefore implemented using special-purpose components implemented purely via hardware design or may utilize hardware components of the apparatus 200 that execute computer software designed to facilitate performance of the functions of the communications circuitry 206, input/output circuitry 208, product inventory circuitry 210, delivery network circuitry 212, estimate reconciliation circuitry 214, and machine learning circuitry 216.

As illustrated in FIG. 3, an apparatus 300 is shown that represents an example customer device (e.g., any of devices 114A-114N) or store device (e.g., any of devices 110A-110N). In some embodiments, each of the one or more customer devices 114A-114N may be associated with a particular customer, and/or each of the store devices 110A-110N may be associated with a particular store. In this manner, for example, a customer can order parts while present at an auto repair garage using the customer's own device, or the customer can visit an auto parts store and order parts from the auto parts store. The apparatus 300 includes processor 302, memory 304, communications circuitry 306, and input-output circuitry 308, each of which is configured to be similar to the similarly named components described above in connection with FIG. 2.

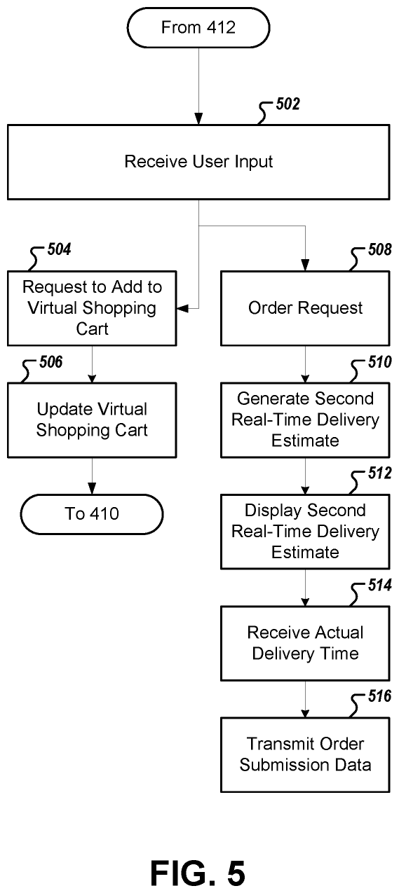

However, the apparatus 300 also includes user interface circuitry 310, which includes hardware components designed for displaying, via a user interface, delivery information to a user. The user interface circuitry 310 may utilize processor 302, memory 304, or any other hardware component included in the apparatus 300 to perform these operations, as described in connection with FIG. 5 below. The user interface circuitry 310 may further utilize communications circuitry 306 to receive delivery information from the delivery data system 102, or may otherwise utilize processor 302 and/or memory 304 to provide delivery information to and store delivery information from a user.

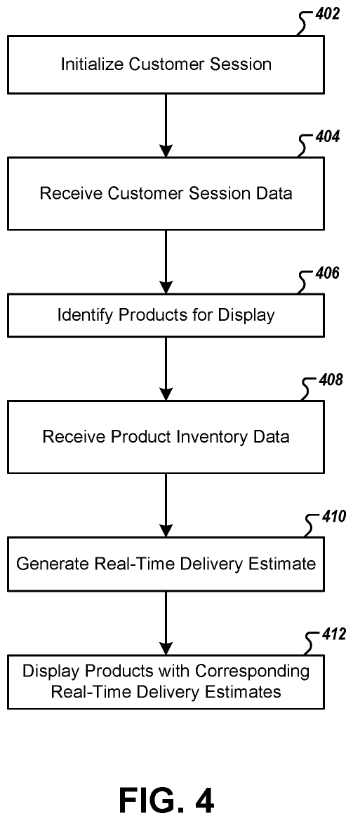

In addition, the apparatus 300 also includes customer session circuitry 312, which includes hardware components designed for receiving, generating, organizing, storing, and transmitting customer session data. The customer session circuitry 312 may utilize processor 302, memory 304, or any other hardware component included in the apparatus 300 to perform these operations, as described in connection with FIG. 4 below. The customer session circuitry 312 may further utilize communications circuitry 306 to receive customer session data from delivery data system 102 and/or memory 304, or may otherwise utilize processor 302 to organize and store the customer session data within local memory 304. For example, in some embodiments, the customer session circuitry 312 may receive customer session data and store the customer session data in local memory 304. In some embodiments, memory 304 may comprise one or more high performance caches. In this regard, the customer session circuitry 312 may store customer session data in a first high performance cache to increase the speed and efficiency of data retrieval.

As used herein, customer session data relates to delivery information associated with a customer session. In some embodiments, the customer session data associated with the customer session may comprise customer data, store network data, delivery network data, and/or shopping cart data.

Customer data, as referenced herein, relates to customer information relevant to a customer session. For example, the customer data may identify the physical location of a customer. In addition, in some embodiments, the customer data may identify one or more car makes, one or more car models, one or more time limits, one or more budgets, etc.

Store network data, as referenced herein, relates to the one or more stores associated with the store devices 110A-110N. In some embodiments, the store network data may identify information associated with the one or more stores. For example, the store network data may identify one or more physical locations associated with each of the one or more stores. In addition, in some embodiments, the store network data may identify one or more store specialties, employees, managers, hours of operation, preferences, etc.

Delivery network data, as referenced with respect to the customer session data, is similar to the delivery network data described above. In some embodiments, the customer session circuitry 312 may be configured to receive delivery network data from the delivery data system 102 and store the delivery network data with the customer session data in local memory 304.

Shopping cart data, as referenced herein, relates to one or more products. In some embodiments, the shopping cart data may identify one or more products in a virtual shopping cart. However, shopping cart data is not limited to a final screen or image of a user interface displayed immediately before an order is placed. Indeed, shopping cart data may include screens or images of a user interface earlier in the product selection process, such as products existing on one or more virtual shelf screens prior to those products being placed into a virtual shopping cart. Moreover, in some embodiments, the shopping cart data may identify information associated with the one or more products. For instance, in some embodiments, the shopping cart data may identify locations with the one or more products. Moreover, in some embodiments, the shopping cart data may identify an estimated delivery time associated with the one or more products.

In addition, the apparatus 300 also includes partial product inventory circuitry 314, which includes hardware components designed for receiving, organizing, storing, and transmitting a portion of the product inventory data described above. The partial product inventory circuitry 314 may utilize processor 302, memory 304, or any other hardware component included in the apparatus 300 to perform these operations, as described in connection with FIG. 4 below. The partial product inventory circuitry 314 may further utilize communications circuitry 306 to receive product inventory data from the delivery data system 102, or may otherwise utilize processor 302 to organize and store a portion of the product inventory in local memory 304. For example, in some embodiments, the partial product inventory circuitry 314 may receive product inventory data from the delivery data system 102 and store a portion of the product inventory data in local memory 304. As described above, in some embodiments, the memory 304 may be divided into one or more high performance caches. Moreover, in some embodiments, the partial product inventory circuitry 314 may store a portion of the product inventory data in a second high performance cache to increase the speed and efficiency of data retrieval.

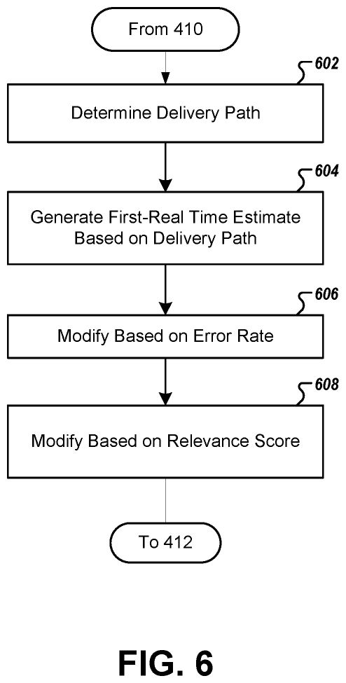

In addition, the apparatus 300 also includes delivery estimate circuitry 316, which includes hardware components designed for receiving delivery information and generating one or more real-time delivery estimates based on the customer session data and/or product inventory data. The delivery estimate circuitry 316 may utilize processor 302, memory 304, or any other hardware component included in the apparatus 300 to perform these operations, as described in connection with FIG. 6 below. The delivery estimate circuitry 316 may further utilize communications circuitry 306 to receive product inventory data from the delivery data system 102 and customer session data from memory 304. The delivery estimate circuitry 316 may further utilize processor 302 to generate and store one or more real-time delivery estimates in local memory 304.

In some embodiments, various components of the apparatuses 200 and 300 may be hosted remotely (e.g., by one or more cloud servers) and thus need not physically reside on the corresponding apparatus 200 or 300. Thus, some or all of the functionality described herein may be provided by third party circuitry. For example, a given apparatus 200 or 300 may access one or more third party circuitries via any sort of networked connection that facilitates transmission of data and electronic information between the apparatus 200 or 300 and the third party circuitries. In turn, that apparatus 200 or 300 may be in remote communication with one or more of the other components described above as comprising the apparatus 200 or 300.

As will be appreciated based on this disclosure, example embodiments contemplated herein may be implemented by an apparatus 200 or 300. Furthermore, embodiments may take the form of a computer program product on at least one non-transitory computer-readable storage medium (e.g., memories 204 or 304) storing software instructions. Any suitable non-transitory computer-readable storage medium may be utilized, some examples of which are non-transitory hard disks, CD-ROMs, flash memory, optical storage devices, and magnetic storage devices. It should be appreciated, with respect to certain devices embodied by apparatus 200 as described in FIG. 2 or apparatus 300 as described in FIG. 3, that loading the software instructions onto a computer or apparatus produces a special-purpose machine comprising the means for implementing various functions described herein.

Having described specific components of example apparatuses 200 and 300, example embodiments are described below in connection with a series of flowcharts.

### Example Operations for Delivery Interface System

Turning to FIGS. 4, 5, and 6, example flowcharts are illustrated that contain operations implemented by example embodiments described herein. The operations illustrated in FIGS. 4, 5, and 6 may, for example, utilize or be performed by one or more of the apparatuses shown in FIG. 1, and described in FIGS. 2 and 3, such as apparatus 200, which illustrates an example delivery data system 102, or apparatus 300, which illustrates an example customer device 114 or store device 110. For example, the various operations described in connection with FIGS. 4, 5, and 6 may be performed by an apparatus 300, which may utilize one or more of processor 302, memory 304, communications circuitry 306, input-output circuitry 308, user interface circuitry 310, customer session circuitry 312, partial product inventory circuitry 314, delivery estimate circuitry 316, and/or any combination thereof.

Turning first to FIG. 4, example operations are shown for a computer-implemented method and apparatus of generating and displaying real-time delivery estimates.

As shown by operation 402, the apparatus 300 includes means, such as user interface circuitry 310, customer session circuitry 312, or the like, for initializing a customer session. In some embodiments, a user may initialize a customer session by interacting with the user interface circuitry 310. For example, in some cases, the user interface circuitry 310 may display a virtual interactive start button. In such a case the user may select the start button to initialize the customer session. In some embodiments, the user interface circuitry 310 may provide a login page to the user with virtual interactive login fields. In such an embodiment, the user may enter login credentials and the user interface circuitry 310 may initialize the customer session after verifying the entered credentials. In addition, in some embodiments, the customer session circuitry 312 may be configured to receive and store a start time associated with the customer session after the user interface circuitry 310 initializes the customer session.

As shown by operation 404, the apparatus 300 includes means, such as communications circuitry 306, input-output circuitry 308, user interface circuitry 310, customer session circuitry 312, or the like, for receiving customer session data associated with the customer session. As described above, the customer session data associated with the customer session may comprise customer data, store network data, delivery network data, and shopping cart data.

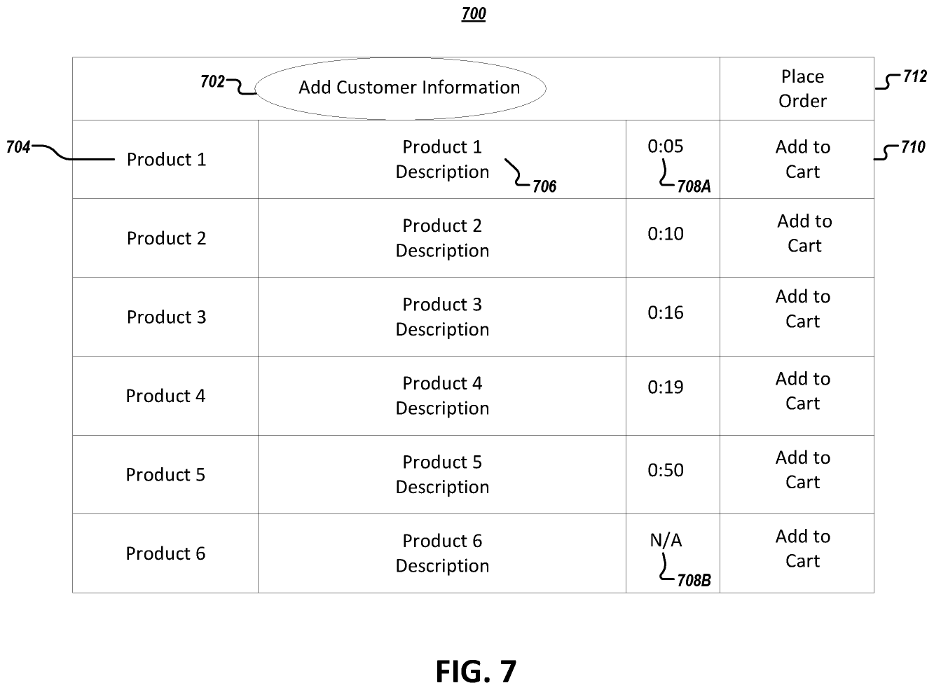

In some embodiments, the customer data, described in detail above, may be received from a user via the user interface circuitry 310 after the customer session is initialized. For instance, upon initialization of a customer session a user may transmit information to the user interface circuitry 310 via a user interface and the user interface circuitry 310 may store the customer session data in memory 304. In some embodiments, the user interface circuitry 310 may prompt a user for customer information. For example, after the user initializes the customer session, the user interface circuitry 310 may display via a user interface one or more fields requesting customer information (see FIG. 7). In response, the user may input customer information by completing the one or more fields. In addition and/or alternatively, in some embodiments the customer session circuitry 312 may determine customer data without user input. For instance, the customer session circuitry 312 may receive external data such as GPS and/or map data and, based on the GPS and/or map data, determine a customer's physical location. In this regard, the customer session circuitry 312 may apply any combination of user input and/or external data to gather customer data.

The store network data, described in detail above, may identify one or more stores. In some embodiments, the customer session circuitry 312 may generate the store network data after identifying one or more stores within a determined delivery range. In this regard, the one or more stores may comprise a subset of stores that are capable of servicing a delivery request. The customer session circuitry 312 may determine that the subset of stores are within a delivery range capable of servicing a delivery request when the stores are within a particular distance from a customer's physical position.

In some embodiments, the particular distance from the customer's physical location may include a predetermined distance. For example, in some embodiments, the customer session circuitry 312 may determine that all stores within 25 miles of the customer's physical location are capable of servicing a delivery request. In this instance, the customer session circuitry 312 may generate store network data identifying the subset of one or more stores within 25 miles of the customer's physical location.

In some embodiments, customer session circuitry 312 dynamically determines the particular distance from the customer's physical location based on one or more factors. In this regard, the distance may depend on the customer's surrounding environment, the number of stores within the subset at any given distance, the customer's personal preferences, time constraints, and/or budget constraints, etc. For example, if the customer's physical location indicates that the customer is located within a city, the customer session circuitry 312 may determine that all stores within 10 miles of a customer are capable of servicing a delivery request. However, in another example embodiment, if the customer's physical location indicates that the customer is located in a rural area, the customer session circuitry 312 may determine that all store within an expanded radius of 30 miles are capable of servicing a delivery request.

Moreover, in some cases, the particular distance from a customer's physical location may be predetermined or determined dynamically depending on the particular store associated with a particular store device 110A-110N. For example, an auto parts store located in a busy area may wish to configure the customer session circuitry 312 to search within a predetermined area in order to reduce the subset of stores. On the other hand, an auto parts store located in a less populated area may be more flexible and, consequently, wish to configure the customer session circuitry 312 to search dynamically.

In some embodiments, the delivery network data, described in detail above, identifies information about one or more vehicles. As described above, in some embodiments, the delivery network data is received by the delivery network circuitry 212 of the delivery data system 102. In some embodiments, the delivery network circuitry 212 may transmit the delivery network data to the customer session circuitry 312 of the store device. For example, in some embodiments, the customer session circuitry 312 may request delivery network data from the delivery network circuitry 212 after a customer session is initialized. In response, the delivery network circuitry 212 may transmit the delivery network data to the store device 110A-110N associated with the customer session circuitry 312. In some embodiments, the customer session circuitry 312 may request a portion of the delivery network data based on the customer's location. In this case, the delivery network circuitry 212 may transmit only the portion requested.

In some embodiments, the customer session circuitry 312 may dynamically update the delivery network data. For example, the customer session circuitry 312 may be configured to request updated delivery network data from the delivery network circuitry 212 in response to a delivery network refresh trigger. For instance, the customer session circuitry 312 may include a timer and a preset time interval. In this instance, every completion of the preset time interval may trigger the customer session circuitry 312 to request updated delivery network data and/or a portion of delivery network data. In this regard, the time interval may be preset and/or change depending on a number of factors. For instance, the time interval may comprise shorter time segments during busy hours of the day and longer time segments during quieter hours of the day. In other embodiments, the customer session circuitry 312 may be configured to receive updated delivery network data as changes occur. For instance, the delivery network circuitry 212 may be configured to transmit updated delivery network data to the customer session circuitry 312 upon detecting a modification to the delivery network data.

In some embodiments, the shopping cart data, described in detail above, identifies one or more products in a virtual shopping cart. In some embodiments, the shopping cart data may be associated with a customer session. For instance, the customer session circuitry 312 may track one or more products selected and placed within a virtual shopping cart during a customer session via the user interface circuitry 310. Moreover, the shopping cart data may be associated with one or more particular customers. For instance, in some embodiments, the customer session circuitry 312 may track one or more virtual shopping carts associated with one or more customers during one or more customer sessions. For example, a user may select one or more products for a particular customer during a first customer session but fail to order the one or more products in the virtual shopping cart during the first customer session. In this case, the customer session circuitry 312 may identify the one or more products selected in the first customer session at the outset of a second customer session initialized for the particular customer.

As shown by operation 406, the apparatus 300 includes means, such as user interface circuitry 310, customer session circuitry 312, partial product inventory circuitry 314, or the like, for identifying one or more products to be displayed via a user interface. In some embodiments, the user interface circuitry 310 may identify and display all products offered by the one or more stores associated with store devices 110A-110N. In some embodiments, the user interface circuitry 310 may identify and display one or more products based on customer session data sourced from the customer session circuitry 312. For example, the user interface circuitry 310 may display one or more products based on the products relevance to the customer data. In this regard, the user interface circuitry 310 may identify and display all products available within the subset of stores identified by the store network data.

As shown by operation 408, the apparatus 300 includes means, such as memory 304, communications circuitry 306, partial product inventory circuitry 314, delivery estimate circuitry 316, or the like, for receiving product inventory data about one or more products. The delivery estimate circuitry 316 may receive the product inventory data, described in detail above, from the delivery data system 102 via communications circuitry 306. Additionally or alternatively, in some embodiments, the delivery estimate circuitry 316 may receive a portion of the product inventory data from local memory 304. In this regard, the partial product inventory circuitry 314 may determine a portion of the product inventory data to be stored in local memory 304. The partial product inventory circuitry 314 may determine the portion of the product inventory to be stored based on the product inventory data. For instance, in some embodiments, the partial product inventory circuitry 314 may determine a portion of the product inventory data to be stored based on a product sale rate corresponding to each of the one or more products. In this regard, the partial product inventory circuitry 314 may select a portion of the product inventory data based on a predefined sale rate threshold. For instance, the portion of product inventory data may include all products determined to be “best sellers” as indicated by exceeding the predefined sale rate threshold. Further, in some embodiments, the partial product inventory circuitry 314 may determine the portion of product inventory data to be stored based in part on the particular store associated with the store device and/or the customer session data. For instance, in some embodiments, the partial product inventory circuitry 314 may determine the portion of the product inventory data based on products unavailable in the particular store associated with the store device. Additionally or alternatively, where the store associated with the store device is an auto parts store, the product inventory circuitry 314 may determine the portion of the product inventory data based on a particular customer's vehicle. In addition, the product inventory circuitry 314 may determine the portion of the product inventory databased on a particular job to be performed on a vehicle, such as all of the parts needed for a brake job for the particular vehicle. As a further example embodiment, the product inventory circuitry 314 may determine the portion of the product inventory data to include one or more products researched or reviewed in a prior customer session at the outset of a new customer session initialized for the particular customer.

As described above, in some embodiments, the partial product inventory circuitry 314 may store the portion of product inventory data in local memory 304 such as in a second high performance cache. Due to the variable nature of the delivery system 100, the accuracy of the displayed information may change over time depending on the customer session data and the product inventory data. Thus, in order to display the most accurate and updated information, the user interface circuitry 310 may frequently query the customer session data and a portion of the product inventory data. Frequent queries to a remote server such as the delivery data system 102 may hamstring the user interface circuitry 310 by increasing the speed of data retrieval necessary to display accurate up-to-date delivery information. However, by storing the customer session data in a first local memory 304, such as in a first high performance cache, and a portion of product inventory data in a second local memory 304, such as a second high performance cache, the apparatus 300 may enhance the speed of data retrieval. In this manner, the first and second high performance caches provide an improvement over conventional delivery systems by empowering the user interface circuitry 310 to provide a seamless, up-to-date depiction of relevant products.

As shown by operation 410, the apparatus 300 includes means, such as processor 302, delivery estimate circuitry 316, or the like, for generating a first real-time delivery estimate for each of the one or more products based on the customer session data and the product inventory data. As described in further detail below with reference to FIG. 5, the delivery estimate circuitry 316 generates a real-time delivery estimate for each of the one or more products identified for display by the user interface circuitry 310. The real-time delivery estimate indicates an estimated time of delivery of each of the corresponding products to the customer's physical location. By leveraging the customer session data and the product inventory data the delivery estimate circuitry 316 may determine real-time delivery estimates accurate to within 5-10 minutes. The delivery estimate circuitry 316 may thereafter store the one or more real-time delivery estimates in local memory 304.

In some embodiments, the delivery estimate circuitry 316 may dynamically refresh the real-time delivery estimates. For example, the delivery estimate circuitry 316 may be configured to generate updated real-time delivery estimates in response to a real-time delivery estimate refresh trigger. For instance, the delivery estimate circuitry 316 may include a timer and a preset time interval. In this instance, every completion of the preset time interval may trigger the delivery estimate circuitry 316 to refresh the one or more real-time delivery estimates. In other embodiments, as described in further detail with regard to FIG. 5, the delivery estimate circuitry 316 may be configured to refresh the one or more real-time delivery estimates upon receiving a notification of one or more changes to product inventory data and/or customer session data.

Finally, as shown by operation 412, the apparatus 300 includes means, such as user interface circuitry 310, or the like, for displaying the one or more products and the first real-time delivery estimate for each of the one or more products relative to the corresponding product. The user interface circuitry 310 identifies real-time delivery estimates corresponding to the one or more products identified for display and displays the real-time delivery estimates relative to the corresponding product to the user via the user interface. In some embodiments, the user interface circuitry 310 may request real-time delivery estimates after identifying the one or more products to be displayed. In such an embodiment, the delivery estimate circuitry 316 may determine real-time delivery estimates for particular products as the products are identified by the user interface circuitry 310. In other embodiments, the delivery estimate circuitry 316 may determine real-time delivery estimates for each of the one or more products identified by the product inventory data and store the one or more real-time delivery estimates in local memory 304. In this manner, the user interface circuitry 310 may retrieve up-to-date corresponding real-time delivery estimates depending on the products identified for display from local memory 304.

As described above, example embodiments provide methods and apparatuses that enable improved delivery orders by generating and displaying holistic product data before the product is selected for delivery. Example embodiments thus provide tools that overcome the problems faced by conventional delivery systems. By avoiding the need to manually perform delivery estimates for a plurality of products, example embodiments thus save time and resources, while also eliminating the possibility of human error that has been unavoidable in the past. Finally, the speed and consistency of the evaluations performed by example embodiments unlocks many potential new functions that have historically not been available, such as the ability to conduct near-real-time delivery estimates even when those estimates depend on a number of dynamically changing variables.

Turning next to FIG. 5, example operations are shown for a computer-implemented method and apparatus of accepting and responding to user input via the user interface of a dynamic delivery system.

As shown by operation 502, the apparatus 300 includes means, such as user interface circuitry 310, or the like, for receiving user input. For example, the user interface circuitry 310 may be configured to accept and respond to user input to the user interface.

As shown by operation 504 the apparatus 300 includes means, such as user interface circuitry 310, or the like, for receiving a user input indicating the addition of one or more products to the virtual shopping cart. In some embodiments, the user interface may display a virtual shopping cart button 710 (FIG. 7) relative to each of the one or more displayed products. The user interface circuitry 310 may receive a user input indicating one or more virtual shopping cart buttons 710 associated with the one or more displayed products.

As shown by operation 506, the apparatus 300 includes means, such as user interface circuitry 310, customer session circuitry 312, or the like, for updating the virtual shopping cart, based on the indicated products. In response to receiving user input indicative of one or more products, the user interface circuitry 310 transmits data indicative of the one or more products to the customer session circuitry 312. The customer session circuitry 312 may then update the virtual shopping cart related to the shopping cart data associated with the customer session data.

As discussed above with reference to operation 410 of FIG. 4, the apparatus 300 includes means, such as delivery estimate circuitry 316 or the like, for determining the first real-time delivery estimate for each of the one or more products based on the shopping cart data associated with the customer session data. In this manner, upon identifying changes to the shopping cart data, such as in the case discussed above with reference to operation 506, the delivery estimate circuitry 316 may be configured to refresh the first real-time delivery estimate for each of the one or more products based on the changes to the shopping cart data. For instance, when a product is added to the virtual shopping cart, the customer session circuitry 312 and/or the user interface circuitry 310 may notify the delivery estimate circuitry 316. In response, the delivery estimate circuitry 316 may generate a refreshed first real-time delivery estimate for each of the one more displayed products and store the refreshed first real-time delivery estimates in the local memory 304. Thereafter, the delivery estimate circuitry 316 may notify the user interface circuitry 310 and the user interface circuitry 310 may display the refreshed real-time delivery estimates. In this manner, the user interface circuitry 310 may provide an interactive user interface, wherein the user may view changes in delivery times in real-time as products are added to a virtual shopping cart. Thus, enabling the user to quickly manipulate an order based on timing incentives.

As shown by operation 508, the apparatus 300 includes means, such as user interface circuitry 310 or the like, for receiving, by a user interface, a user input indicating an order request. In some embodiments, the user interface may display an interactive virtual order button 712 indicative of requesting an order for delivery. In an embodiment, the user interface circuitry 310 may receive a user input indicative of the request for delivery and in response generate an order entry identifying the one or more products in the virtual shopping cart.

As shown by operation 510, the apparatus 300 includes means, such as delivery estimate circuitry 316 or the like, for generating a second real-time delivery estimate for the one or more products in the virtual shopping cart. In some embodiments, after an order entry is created the user interface circuitry 310 may request a second real-time delivery estimate for the one or more products in the virtual shopping cart. In response, the delivery estimate circuitry 316 may create a more granulized second real-time delivery estimate based on the one or more products in the virtual shopping cart. In some embodiments, the second real-time delivery estimate may be more accurate than the first real-time delivery estimate. For example, because an order entry identifies a smaller subset of products than the product inventory data, the delivery estimate circuitry 316 may devote additional processing power to generate the second real-time delivery estimate. The delivery estimate circuitry 316 may also introduce more input data sources to the calculations, such as real-time traffic and weather data, and individualized location data for a particular delivery driver in order to generate a more accurate second real-time delivery estimate. In addition, additional real-time delivery estimates may be generated, such as third and fourth real-time delivery estimates, etc., which may be useful when additional customer screens or decision points are introduced into embodiments of the present disclosure. As an example, once a first product has been delivered, updated real-time delivery estimates may be generated for the remaining products still en route to the customer or store.

As shown by operation 512, the apparatus 300 includes means, such as user interface circuitry 310 or the like, for displaying, by a user interface, the second real-time delivery estimate. After the second real-time delivery estimate is generated, the user interface circuitry 310 may display the second real-time delivery estimate via the user interface. In some embodiments, the user interface circuitry 310 may present a countdown timer, wherein the time begins with the second real-time delivery estimate and progressively counts down as time elapses. In addition or alternatively, the user interface circuitry 310 may generate and display an order summary indicative of the one or more products in the virtual shopping cart and the second real-time delivery estimate.

As shown by operation 514, the apparatus 300 includes means, such as user interface circuitry 310, or the like, for receiving an actual delivery time following delivery of the one or more products. In some embodiments, the user interface circuitry 310 may receive an actual delivery time indicating the actual time of delivery of the one or more products indicated by the virtual shopping cart. In some embodiments, the user may interact with the user interface to indicate the actual time of delivery. In response, the user interface circuitry 310 may store the actual time of delivery in local memory 304.

In addition or alternatively, the user interface circuitry 310 may monitor the delivery network data to determine the actual time of delivery. For instance, in some embodiments, after an order is requested, the user interface circuitry 310 may generate one or more tasks for one or more vehicles identified by the delivery network data. The user interface circuitry 310 may then transmit the one or more tasks to the delivery data system 102. In response, the delivery data system 102 may transmit the one or more tasks to the one or more vehicles devices 112A-112N. Upon completing the one or more tasks, the one or more vehicle devices 112A-112N may notify the delivery data system 102, which in turn may notify the user interface circuitry 310.

Finally, as shown by operation 516, the apparatus 300 includes means, such as memory 304 or the like, for storing order submission data identifying the customer session data associated with the customer session, the second real-time delivery estimate, the actual delivery time, current traffic data, current environmental data, and current local event data. In some embodiments, the apparatus 300 may transmit order submission data to the delivery data system 102. The order submission data may be collected from local memory 304 and/or include external data collected from external sources via the communications circuitry 306.

As used herein, order submission data refers to any information regarding the order entry associated with the customer session. For example, the order submission data may provide information such as customer session data, product inventory data, first real-time delivery estimate data, second real-time delivery data, actual delivery time data, current traffic data, current environmental data such as weather data, and/or current event data, etc.

As described above, example embodiments provide methods and apparatuses that enable improved delivery orders by providing an interactive user interface, wherein the user may view changes in delivery times in real-time as products are added to the virtual shopping cart. Example embodiments thus provide tools that overcome the problems faced by conventional delivery systems. By refreshing real-time delivery estimates based on the user's perusal of the user interface, example embodiments enable more informed shopping decisions saving time and resources, while avoiding the potential for delivery delays. Moreover, automatically displaying the refreshed real-time delivery estimates, offers an improvement over conventional delivery interfaces by enabling more nuanced product filtering based on the displayed changes to estimated delivery times. Rather than requiring a user to navigate through multiple windows to view/calculate particular times, example embodiments enable a user to easily view a list of products along with corresponding up-to-date real-time delivery estimates without interrupting an order for delivery.

Turning next to FIG. 6, example operations are shown for generating real-time delivery estimates for the one or more products as shown by operation 410 in FIG. 4.

As shown by operation 602, the apparatus 300 includes means, such as delivery estimate circuitry 316 or the like, for determining a delivery path associated with each of the one or more products. In some embodiments, the delivery estimate circuitry 316 may determine an estimated delivery path associated with each of the one or more products based on the customer session data and the product inventory data associated with the customer session. In some embodiments, the delivery estimate circuitry 316 may generate one or more potential delivery paths for each of the one or more products based on each location associated with each of the one or more products and the customer's physical location. The delivery estimate circuitry 316 may then determine the most efficient path based on additional customer session, product inventory and/or external data. For example, the delivery estimate circuitry 316 may determine the most efficient delivery path based on one or more store locations associated with the each of the one or more products in the virtual shopping cart.

As shown by operation 604, the apparatus 300 includes means, such as delivery estimate circuitry 316 or the like, for generating a first real-time delivery estimate for each of the one or more products based on the delivery path associated with each of the one or more products. The delivery estimate circuitry 316 may generate the first real-time delivery estimate associated with the one or more products based on the determined most efficient delivery path. In this manner, the delivery estimate circuitry 316 may generate one first real-time delivery estimate for each of the one or more products based on the most efficient predetermined path.

As shown by operation 606, the apparatus 300 includes means, such as delivery estimate circuitry 316 or the like, for modifying the first real-time delivery estimate for each of the one or more products based on the one or more error rates. As discussed in greater detail above, in some embodiments, the estimate reconciliation circuitry 214 may transmit one or more error rates to the delivery estimate circuitry 316. For example, one or more error rates associated with the historical data may indicate a positive difference. For instance, the average difference between the actual delivery times minus real-time delivery estimates may indicate that the delivery estimate circuitry 316 has consistently underestimated by 1 minute when generating the real-time delivery estimates of past deliveries. In this case, the delivery estimate circuitry 316 may modify the first real-time delivery estimate of the one or more products by adding the difference (i.e. 1 minute) to the real-time delivery estimates for each of the one or more products associated with the customer session. In this manner, the delivery estimate circuitry 316 may leverage historical data to create more precise real-time delivery estimates based on actual delivery times in past deliveries. Thereby, increasing the accuracy of the real-time delivery estimates over time.

As shown by operation 608, the apparatus 300 includes means, such as processor 302, memory 304, communications circuitry 306, input-output circuitry 308, user interface circuitry 310, customer session circuitry 312, partial product inventory circuitry 314, delivery estimate circuitry 316, or the like, for modifying the first real-time delivery estimate for each of the one or more products based on the one or more relevance scores. As discussed in greater detail above, in some embodiments the machine learning circuitry 216 of apparatus 200 may generate the one or more relevance scores based on one or more components of historical data. For instance, the delivery estimate circuitry 316 may transmit customer session data to the machine learning circuitry 216 of an apparatus 200 and, in response, may receive one or more relevance scores associated with the customer session data. The one or more relevance scores may identify modifications to the first real-time delivery estimate for the one or more products associated with the customer session. For example, a relevance score may identify a shorter first real-time delivery estimate for a particular location. In such a case, the delivery estimate circuitry 316 may modify the one or more first real-time delivery estimates for each of the one or more products associated with the particular location by generating a shorter first real-time delivery estimate. Conversely, the relevance score may identify a longer first real-time delivery estimate for a particular location, in which case the delivery estimate circuitry 316 may modify the one or more first real-time delivery estimates for each of the one or more products associated with the particular location by generating a longer first real-time delivery estimate.

As discussed above, in some embodiments, the relevance scores may be associated with data other than customer session data. For example, in some embodiments, the machine learning circuitry 216 may provide a relevance score based on one or more components of historical data identifying historical product deliveries that occurred in similar weather. The one or more components of historical data may suggest a longer first real-time delivery estimate during thunderstorms than during other weather. In addition, the machine learning circuitry 216 may identify, based on a customer's physical location and external weather data that delivery estimates during thunderstorms are relevant to the first real-time delivery estimates associated with one or more products associated with the customer session (i.e. the customer's physical location is within a thunderstorm). In response, the machine learning circuitry 216 may transmit one or more relevance scores indicative of a longer first real-time delivery estimate for the one or more products associated with the customer session. Other data that may be associated with relevance scores include traffic data, an identification of a time of year, whether a current day is a holiday, time of day, or the like.

As described above, example embodiments provide methods and apparatuses that enable improved delivery estimates for one or more products at one or more different locations. Example embodiments thus provide tools that overcome the problems faced by conventional delivery systems. By providing more granulized delivery estimates that increase with accuracy over time, example embodiments improve conventional delivery system capabilities, while increasing the speed, accuracy, and precision of delivery orders involving multiple products from a number of potentially different locations.

As these examples all illustrate, example embodiments contemplated herein provide technical solutions that solve real-world problems present in conventional delivery systems including e-commerce portals in use today. And while a lack of accurate timing information provided before a user has created an order for delivery has been an issue for decades, the recent logistical revolution linked to emerging computing technology today has made this problem significantly more acute, as the demand for time sensitive logistical information has grown significantly even while the complexity of logistical networks has itself increased. At the same time, the recently arising ubiquity of sophisticated computing devices with access to e-commerce portals has unlocked new avenues to solving this problem that historically were not available, and example embodiments described herein thus represent a technical solution to these real-world problems.

FIGS. 4, 5, and 6 illustrate flowcharts describing sets of operations performed by apparatuses, methods, and computer program products according to various example embodiments. It will be understood that each block of the flowcharts, and combinations of blocks in the flowcharts, may be implemented by various means, embodied as hardware, firmware, circuitry, and/or other devices associated with execution of software including one or more software instructions. For example, one or more of the operations described above may be embodied by software instructions. In this regard, the software instructions which embody the procedures described above may be stored by a memory of an apparatus employing an embodiment of the present invention and executed by a processor of that apparatus. As will be appreciated, any such software instructions may be loaded onto a computer or other programmable apparatus (e.g., hardware) to produce a machine, such that the resulting computer or other programmable apparatus implements the functions specified in the flowchart blocks. These software instructions may also be stored in a computer-readable memory that may direct a computer or other programmable apparatus to function in a particular manner, such that the software instructions stored in the computer-readable memory produce an article of manufacture, the execution of which implements the functions specified in the flowchart blocks. The software instructions may also be loaded onto a computer or other programmable apparatus to cause a series of operations to be performed on the computer or other programmable apparatus to produce a computer-implemented process such that the software instructions executed on the computer or other programmable apparatus provide operations for implementing the functions specified in the flowchart blocks.

The flowchart blocks support combinations of means for performing the specified functions and combinations of operations for performing the specified functions. It will be understood that one or more blocks of the flowcharts, and combinations of blocks in the flowcharts, can be implemented by special purpose hardware-based computer systems which perform the specified functions, or combinations of special purpose hardware and software instructions.

In some embodiments, some of the operations above may be modified or further amplified. Furthermore, in some embodiments, additional optional operations may be included. Modifications, amplifications, or additions to the operations above may be performed in any order and in any combination.

### Example Dynamic User Interface

Turning now to FIG. 7, FIG. 7 illustrates an example embodiment of a user interface 700 provided by the user interface circuitry 310 after a customer session is initiated.

In some embodiments, the user interface 700 may include one or more interactive virtual fields and/or virtual buttons, such as customer information button 702, indicative of inputting customer information. For example, after a customer session is initiated the user may interact with the customer information button 702 to identify one or more characteristics of a customer. In some embodiments the user interacting with the user interface may be the customer. However, in other embodiments a user may interact with the user interface of behalf of a customer, such as a sales associate at an auto parts store ordering for a customer. As another example, in some embodiments, the customer may be a car owner and a user may be a mechanic at an auto repair garage. In this scenario, the mechanic may use customer information to interact with the user interface to view and/or order auto parts required to service the customer's vehicle.

In addition, as described in detail above, the user interface 700 may include one or more products 704. In some embodiments, the one or more products may be provided in a list as illustrated by the example user interface 700. However, in some cases, the one or more products may be displayed relative to a physical location. For instance, in some embodiments, the user interface may include an illustration of a map with one or more physical store locations identified. In such a case, the user interface 700 may display the one or more products relative to one or more locations on the map having the product in stock. Moreover, in some embodiments, although not shown in example embodiment 700, the user interface may include a virtual “toggle button” enabling the user to toggle between one or more views such as a map and list view.

In addition, in some embodiments, the user interface 700 may include a product description 706 describing a corresponding product 704. The product description may include any information related to the corresponding product such as, but not limited to, product information related to the product inventory data discussed in detail above.

In addition, the user interface 700 includes one or more real-time delivery estimates (e.g., example items 708A and 708B in FIG. 7) regarding each corresponding product. The real-time delivery estimates may be displayed in any temporal format including, in some embodiments, timing variables such as days, hours, minutes and/or seconds, etc. In some embodiments, the user interface 700 may display all products regardless of location and/or stock at one or more particular locations. In such an embodiment, the user interface 700 may display real-time delivery estimate 708B where a product is unavailable, but may otherwise display real-time delivery estimate 708A (or any other suitable delivery estimate). However, in another embodiment, the user interface circuitry 310 may screen unavailable products from the user interface. In this manner, the user interface 700 may only display available products. The user interface 700 may also provide a real-time delivery estimate for all of the products displayed indicating when the entire order should be received. This real-time delivery estimate may be equal to the longest real-time delivery estimate of products displayed, thus representing the time estimated for the last of the products to be delivered. However, in some instances, the real-time delivery estimate for the entirety of the products to be delivered may be longer than the longest individual product real-time delivery estimate, such as when the delivery logistics or cost cause a delivery path for a vehicle to stop at multiple stores to pick up products before delivery of the products from the multiple stores. Similarly, the real-time delivery estimate for the entirety of the products to be delivered may be shorter than the longest individual product real-time delivery estimate, such as may be the case when a vehicle or driver has a minimum load size or weight that is required before a delivery run is cost-efficient. In such a case, the entire product order may cause a delivery run to occur prior the delivery run of a vehicle having only one part loaded thereon and awaiting further product orders (such as from other customers).

In addition, in some embodiments, the user interface 700 may include one or more interactive “Add to Cart” virtual shopping cart buttons 710 to add a given product to the user's virtual shopping cart. In some embodiments, as illustrated by example user interface 700, an “Add to Cart” virtual shopping cart button 710 may be displayed in connection with each of the one or more products. As described in detail above, in some embodiments, the user may interact with the “Add to Cart” virtual shopping cart buttons 710 to indicate one or more products to be added to a virtual shopping cart.

Finally, in some embodiments, the user interface 700 may also include one or more interactive virtual order buttons 712. As described in detail above, in some embodiments, the user may interact with the one or more virtual order buttons 712 to place an order request.

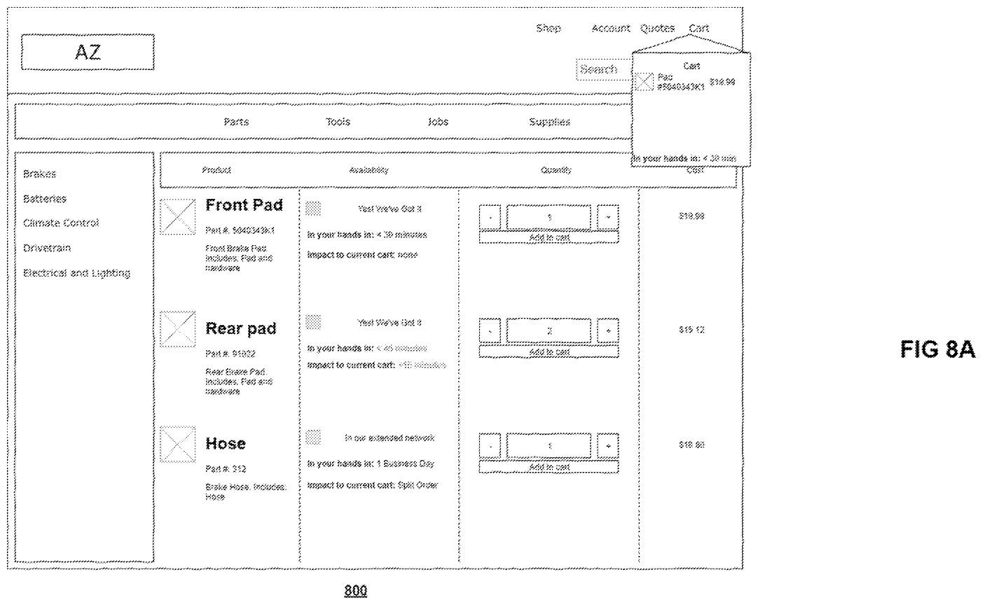

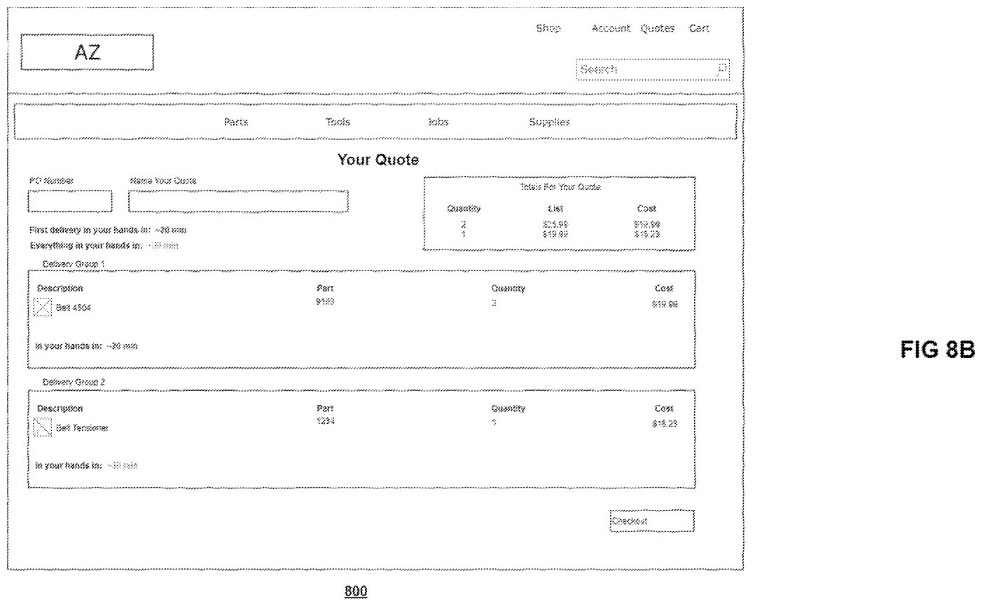

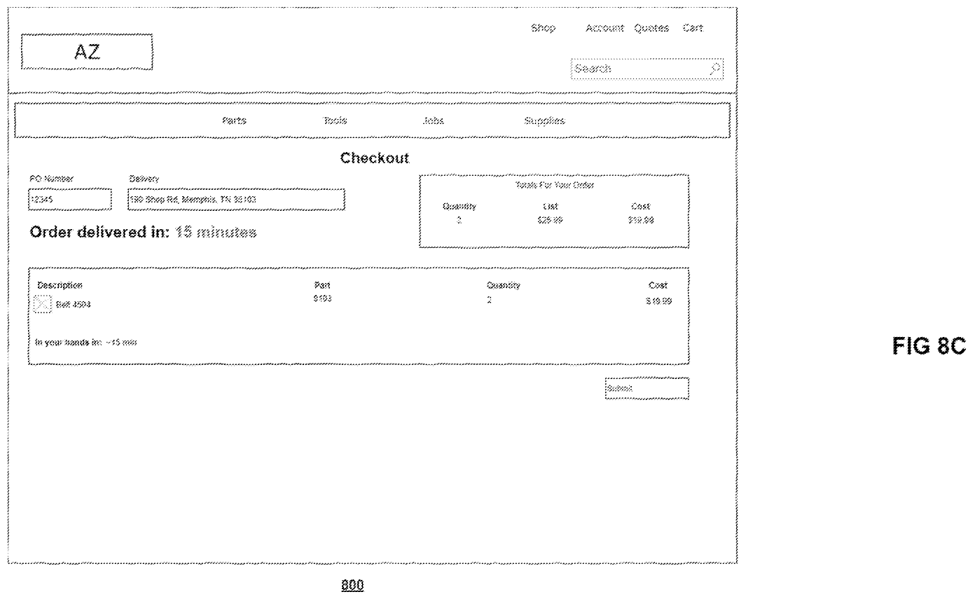

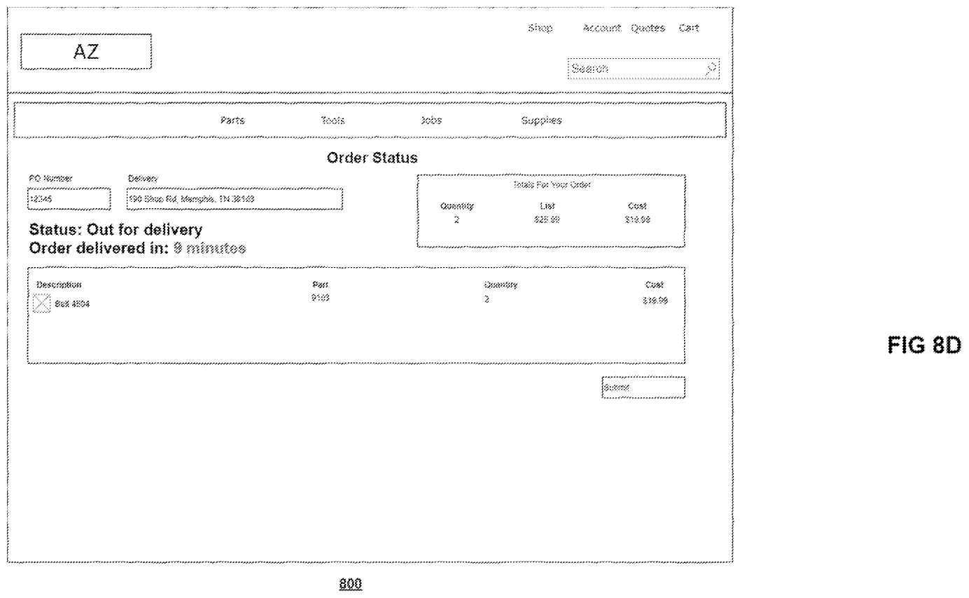

FIGS. 8A-D illustrate additional example user interface provided to a user of the delivery system in and provide specific examples for certain products, such as automobile repair parts. FIG. 8A shows a user interface 800 with three products displayed; a front brake pad, a rear brake pad and a brake hose. The real-time delivery estimates shown include delivery in less than 30 minutes for the front pad. A corresponding cost is also shown. In this example, the user has chosen to add only the front pad to the user's virtual shopping cart. This may be due to the cost, or due to the immediacy with which the customer needs the product part.

The real-time delivery estimate for the rear pad shows that rear pad will be delivered within 45 minutes. Also provided is an estimated increase of 15 minutes for delivery of the entire virtual shopping cart if the rear pad is added to the user's virtual shopping cart. The brake hose is not quickly available and will be delivered in one business day. This may be the case if a local auto parts store does not have the product part in question in inventory, and it must be supplied by the auto parts store's extended network. This extended network may include an auto parts store outside of the geographic area; an auto parts store owned by a different company that has a part sharing arrangement with the order-receiving auto parts store; and a manufacturer, wholesaler or distributor of auto parts. In this case, the user interface 800 notes that the order will be split into a separate delivery order. Thus, from this screen, for example, the user can assess whether he wants to order just the front pad and wait up to 30 minutes, or whether he is willing to wait 45 minutes for the rear pad too. The same is true if the user also wants to wait for a new brake hose, or just proceed with the front and rear pads.

FIG. 8B illustrates a quote screen of the user interface 800 using two different products; a belt and a belt tensioner. The quote screen may comprise, for example, all of the products placed that were previously placed into the virtual shopping cart. In this example, the user is considering buying two belts, for which a real-time delivery estimate of approximately 20 minutes is provided. The user is also considering a belt tensioner for which a real-time delivery estimate of approximately 30 minutes is provided and, in the illustrated example, will comprise a separate delivery group. At the top of the screen, real-time delivery estimates are provided for both the first delivery and the entire order.

FIG. 8C shows a checkout screen for just the two belts from FIG. 8B. The user may have decided at this point, for example, that he does not want to wait for the new belt tensioner and wants to proceed with just the belt. The list price is shown along with the customer's costs, reflecting a discount provided to the customer. On this screen, the real-time delivery estimate is shown as 15 minutes. After the user submits the order, an order status page is shown as in FIG. 8D. In this instance, a second real-time delivery estimate has been provided and shows delivery of the belts in only 9 minutes. This short real-time delivery estimate may be due to real-time traffic and weather data, and/or individualized location data for an assigned delivery driver.

As the above examples illustrate, example embodiments contemplated herein provide technical solutions that solve real-world problems present in conventional delivery systems and/or e-commerce portals. By displaying real-time delivery estimates corresponding to each of the one or product available for delivery before the user selects the product for delivery, the example embodiments increase the speed, accuracy and usability of conventional delivery systems and e-commerce portals, while avoiding unnecessary delays in delivery. Moreover, displaying real-time delivery estimates corresponding to each of the one or more products before a delivery order is created provides for more nuanced product filtering based on a more holistic depiction each product.

As noted above, FIGS. 7 and 8A-D are merely illustrations of example user interfaces for purposes of explanation and should not be construed to limit the invention of the present disclosure. The user interface circuitry 310 of the present disclosure may present delivery information in any number of different formats depending on any number of different factors. While FIGS. 7 and 8A-D illustrate one or more elements contained within the example user interfaces 700 and 800, the present disclosure may include user interfaces with any number and/or combination of additional and/or different elements.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A computer-implemented method for generating and displaying real-time delivery estimates, the method comprising:
initializing a customer session;
receiving customer session data associated with the customer session, the customer session data comprising customer data, store network data, delivery network data, and shopping cart data, wherein the shopping cart data identifies one or more products in a virtual shopping cart associated with the customer session;
identifying one or more products to be displayed via a user interface;
receiving product inventory data about the one or more products, the product inventory data including a product data structure providing information about each product in the one or more products;
generating a real-time delivery estimate for each of the one or more products based on the customer session data and the product inventory data; and
displaying, by a user interface, the one or more products and each corresponding real-time delivery estimate.

2. The method of claim 1, wherein the product data structure identifies, for each particular product in the one or more products, one or more locations having the particular product in stock, a quantity of the particular product available at each of the one or more locations having the particular product in stock, and a pickup cost associated with retrieving the particular product from each of the one or more locations.

3. The method of claim 1, further comprising:
storing, in a first local memory, the customer session data; and
storing, in a second local memory, a portion of the product inventory data.

4. The method of claim 3, further comprising:
determining a portion of the product inventory data to be stored based on a product sale rate corresponding to each of the one or more products.

5. The method of claim 1, wherein generating a real-time delivery estimate for a particular product comprises:
determining a delivery path associated with the particular product based on the customer session data and the product inventory data; and
generating the real-time delivery estimate for the particular product based on the determined delivery path.

6. The method of claim 1, further comprising:
receiving one or more error rates, wherein the one or more error rates are determined by a reconciliation engine based on historical data; and
modifying the real-time delivery estimate for each of the one or more products based on the one or more error rates.

7. The method of claim 1, further comprising:
receiving one or more relevance scores, wherein the one or more relevance scores are determined, using machine learning techniques, for one or more components of historical data.

8. The method of claim 7, further comprising:
modifying the first real-time delivery estimate for each of the one or more products based on the one or more relevance scores.

9. The method of claim 1, further comprising:
receiving, by a user interface, a user input indicating an addition of one or more new products to the virtual shopping cart;
updating the virtual shopping cart based on the user input; and
refreshing the first real-time delivery estimate for each of the one or more products based on the shopping cart data.

10. The method of claim 1, further comprising:
receiving, by a user interface, a user input indicating an order request;
generating a second real-time delivery estimate for the one or more products in the virtual shopping cart;
displaying, by a user interface, the second real-time delivery estimate;
receiving, following delivery of the one or more products, an actual delivery time; and
storing, in a memory, order submission data identifying the customer session data associated with the customer session, the second real-time delivery estimate, the actual delivery time, current traffic data, current environmental data, and current local event data.

11. An apparatus for generating and displaying real-time delivery estimates, the apparatus comprising:
customer session circuitry configured to:
initialize a customer session; and
receive customer session data associated with the customer session, the customer session data comprising customer data, store network data, delivery network data, and shopping cart data, wherein the shopping cart data identifies one or more products in a virtual shopping cart associated with the customer session;
delivery estimate circuitry configured to:
receive product inventory data about one or more products, the product inventory data including a product data structure providing information about each product in the one or more products; and
generate a real-time delivery estimate for each of the one or more products based on the customer session data and the product inventory data;
user interface circuitry configured to:
identify one or more products to be displayed via a user interface; and
display, via a user interface, the one or more products and each corresponding real-time delivery estimate.

12. The apparatus of claim 11, wherein the product data structure identifies, for each particular product in the one or more products, one or more locations having the particular product in stock, a quantity of the particular product available at each of the one or more locations having the particular product in stock, and a pickup cost associated with retrieving the particular product from each of the one or more locations.

13. The apparatus of claim 11,
wherein the customer session circuitry is further configured to:
store, in a first local memory, the customer session data; and
wherein the apparatus further comprises partial product inventory circuitry configured to:
store, in a second local memory, a portion of the product inventory data.

14. The apparatus of claim 13, wherein the partial product inventory circuitry is further configured to:
determine a portion of the product inventory data to be stored based on a product sale rate corresponding to each of the one or more products.

15. The apparatus of claim 11, wherein the delivery estimate circuitry is further configured to generate a real-time delivery estimate for a particular product by:
determining a delivery path associated with the particular product based on the customer session data and the product inventory data; and
generating the real-time delivery estimate for the particular product based on the determined delivery path.

16. The apparatus of claim 11, wherein the delivery estimate circuitry is further configured to:
receive one or more error rates, wherein the one or more error rates are determined by a reconciliation engine based on historical data; and
modify the real-time delivery estimate for each of the one or more products based on the one or more error rates.

17. The apparatus of claim 11, wherein the delivery estimate circuitry is further configured to:
receive one or more relevance scores, wherein the one or more relevance scores are determined, using machine learning techniques, for one or more components of historical data.

18. The apparatus of claim 17, wherein the delivery estimate circuitry is further configured to:
modify the real-time delivery estimate for each of the one or more products based on the one or more relevance scores.

19. The apparatus of claim 11, wherein the apparatus further comprises:
user interface circuitry further configured to:
receive, by a user interface, a user input indicating an addition of one or more new products to the virtual shopping cart; and
update the virtual shopping cart based on the user input,
wherein the delivery estimate circuitry is further configured to:
refresh the real-time delivery estimate for each of the one or more products in response to the user input.

20. The apparatus of claim 11,
wherein the delivery estimate circuitry is further configured to:
generate a second real-time delivery estimate for the one or more products in the virtual shopping cart, and
wherein the user interface circuitry is further configured to:
receive, by a user interface, a user input indicating an order request,
display, by a user interface, a second real-time delivery estimate,
receive, following delivery of the one or more products, an actual delivery time, and
store, in a memory, order submission data identifying the customer session data associated with the customer session, the second real-time delivery estimate, the actual delivery time, current traffic data, current environmental data, and current local event data.
